(19) United States
(12) Patent Application Publication
(10) Pub. No.: US 2004/0102962 A1
(43) Pub. Date: May 27, 2004

(54) Voice reminding system and method of the same

(76) Inventor: Ming-Hsien Wei, PanChao City (TW)

Correspondence Address: BRUCE H. TROXELL, SUITE 1404, 5205 LEESBURG PIKE, FALLS CHURCH, VA, 22041, US

(21) Appl. No.: 10/304,791

(22) Filed: Nov. 27, 2002

(51) Int. Cl. G10L 19/00

(52) U.S. Cl. 704/201

(57) ABSTRACT

The present invention is to disclose a voice reminding system and method of the same, and more particularly to a voice reminding system and method which mainly pre-records different events as voice data, and then arranges a schedule for events through a detailed schedule editing program, and connects the event to the pre-recorded voice data. When an event is about to happen, the system will automatically play the voice data to remind the user and so attain the reminding purpose.

### BACKGROUND OF THE INVENTION

1. Field of the Invention

The present invention is to disclose a voice reminding system and method, which mainly pre-records different events as voice data, and then arranges a schedule for events through a detailed schedule editing program, and connects the event to the pre-recorded voice data. When an event is about to happen, the present invention's system will automatically play the voice data to remind the user and so attain the reminding purpose.

2. Description of the Prior Art

In a busy industrial and commercial society, all sorts of trivial and miscellaneous events are constantly happening, large events such as company meeting times, a schedule for visiting clients, time for work on hold, important days and parents' birthdays, as well as small events such as boiling water, missing the bus stop, and standing up to stretch a bit after sitting in front of the desk for a while.

Traditionally, at most some important events can be recorded on a notebook according to dates and time as shown in FIG. 1. However, the user needs to constantly have a look at their notebook to keep an eye on or prepare for an event that is going to happen, while continuously writing new events and schedules into the notebook for reference anytime and to remind himself not to miss important events. As for trivial and miscellaneous events, or events that won't happen for one year (or several years) or one month (or several months) later ' this traditional method is not sufficient for recording and reminding. With the advancement of technologies along with the invention of computers, “schedules” have been migrated to computers. Currently, Microsoft Outlook is the most representative software. However, its schedule functionality is still defective. For example: (1). It roughly sets schedules every half an hour as a unit. (2). It can only remind the user with words and alarm sound. (3). For a routine event, at most it can only be set for reminding daily, weekly, monthly or yearly.

Planning for schedules using Outlook can't really cover all needs of human life, because people's schedules are very minute and miscellaneous, and all scales of trivial and complicated events interlock with each other. Furthermore, if considering people who are used to the lunar calendar, its complex level truly requires developing another kind of software that can perform very exquisite settings.

Due to the fact that people always have painful experiences when “forgetting something”, there've been attempts at inventing new products to ease the pain, such as the Taiwan patents 308945, 285337 and 222816, etc. However, why isn't there any such product presented to and extensively used by the public? The main issue here is using “how to remind” as a thinking direction, but overlooking the fundamental reason why even the smartest person forgets things, is because there are numerously large and small events all intertwined with each other. Therefore, the crucial problems are “when to remind”, “what to remind”, and how to completely and systematically set a detailed “schedule”. Only when a schedule is completely and specifically set, can people have peace of mind enough to trust their system as their assistant or sectary.

In addition, considering Outlook's distinguishing feature is combining two major functions “appointment schedules” and “E-Mail receiving and sending” in operation. The focus of the present invention is on ways and means for arranging complete and specific schedules, and how to make timely voice reminders through computers, pocket PCs or mobile phones, from which its properties are different from Outlook.

The following describes why the present invention is an innovation and a breakthrough around “when”, “what” and “how” to remind.

When to remind: (When): Except schedules that need to be set for unexpected or randomly performed events, most humans' schedules are actually “regular but often unexpected”. For example, someone wants to drink a glass of water every two hours, but may have to adjust his time because of eating, having afternoon naps or going out. Someone gets up at 6:30 on working days, but doesn't have to get up at the same time during holidays. Someone has to go to a cram school to study every Wednesday night, but it becomes an exception if there is a Wednesday that is a holiday and a school break. A boss's checks expire on the 25^{th} of every month, and he has to deposit money into his check savings account. However, if the 25^{th} of a certain month is a Sunday, he must deposit money one or two days earlier, which becomes an exception. “Exceptions” occur mostly because of “festivals” or “weekends” or “holidays”. As for “regular patterns” they are divided into categories of daily, weekly, monthly, last five days of every month, and yearly. Moreover, for people who or countries that are accustomed to using the lunar calendar, the “lunar calendar” variable must be added. Hence, the significance of the present invention is to “individually” set daily, weekly, monthly, five-day (at the end of every month) and yearly categories with addition of “exceptions” and a “lunar calendar”. Moreover for the lunar calendar, the present invention equally offers convenience of “equivalent” settings with the solar calendar users, and doesn't just display a certain date of a certain year in the solar calendar as a certain date in the lunar calendar. For example, worshiping is needed on the first day of every month in the lunar calendar, and a family member's birthday every year according to the lunar calendar needs to be remembered. It is the most novel part of the present invention.

The present invention further specifies schedules with “minutes” as the smallest unit, and arranges priority for different events happening in the same minute that need to be reminded without conflicts.

What to remind (what): The present invention provides many recorded voice files by recordists (see the right hand side of FIG. 4) for users to select. The user can record his own voice files to remind himself. In addition, brief descriptions for voice files can be set for display on the schedule. The user can choose to display summarized texts on the screen at the same time when reminders are displayed. Besides this the user can load any friends' or family members' speech or voice and music pieces downloaded from the Internet, so as to create a reminder database that is richer and more robust if used longer in this product. Of course, this is also attributed to hard disks' increasing capacity of over 10 GBs at cheap prices in recent years. The present invention uses an open design where the reminding contents can cover everything and can be massively accumulated.

How to remind (how): The present invention's function of outputting background executable files can be implemented on computers, notebook computers, pocket PCs and mobile phones to remind users without having to manufacture a new hardware product with reminding functionality. This is how the present invention differentiates itself from Taiwan patents such as 308945 and 285337.

To summarize the descriptions of when, what and how to remind above, the present invention discloses a voice reminding system and method, which mainly pre-records different events as voice data, and then arranges event times for different events through a specific scheduling program, and connects different events to pre-recorded voice data. When an event occurs, the system will automatically play the related voice data to remind the user the upcoming event and so attain the reminding purpose.

### SUMMARY OF THE INVENTION

The primary aspect of the present invention is to provide a voice reminding system, which includes: a input control unit, the CPU, a data storage unit, a data editing and updating unit, a date changing and searching unit for the lunar/solar calendar, a scheduled event execution unit and a output control unit. This system mainly pre-records different events as voice data, and then arranges a schedule for events through a detailed schedule editing program, and connects the event to the pre-recorded voice data. When an event is about to happen, this system will automatically play the voice data to remind the user and so attain the reminding purpose.

The secondary aspect of the present invention is to provide a voice reminding method, which mainly pre-records different events as voice data, and then arranges a schedule for events through a detailed schedule editing program, and connects the event to the pre-recorded voice data. When an event is about to happen, this system will automatically play the voice data to remind the user and so attain the reminding purpose.

The third aspect purpose of the present invention is to provide a method of playing voice or music pieces, of which its function is similar to an emcee in a meeting. Using this method, the user doesn't need to set time, but simply presses a key to play the next voice piece or music piece, therefore this method can be applied in meeting agenda control, as foil music in dramas, singing and dancing, and for arranging sounds or sound effects in presentations.

To enable the examiners to have a better understanding of the present invention, a more specific illustration is provided in coordination with the following FIGS and icons:

### BRIEF DESCRIPTION OF THE DRAWINGS

FIG. 1 is to illustrate how to use a notebook to arrange schedules in prior art.

FIG. 2 is the system framework of the present invention.

FIG. 3A to FIG. 3B are the software functionality framework of the present invention.

FIG. 4 is the first embodiment of the present invention.

FIG. 5A to FIG. 5D are the second embodiments of the present invention.

FIG. 6 is the third embodiment of the present invention.

FIG. 7 is the fourth embodiment of the present invention.

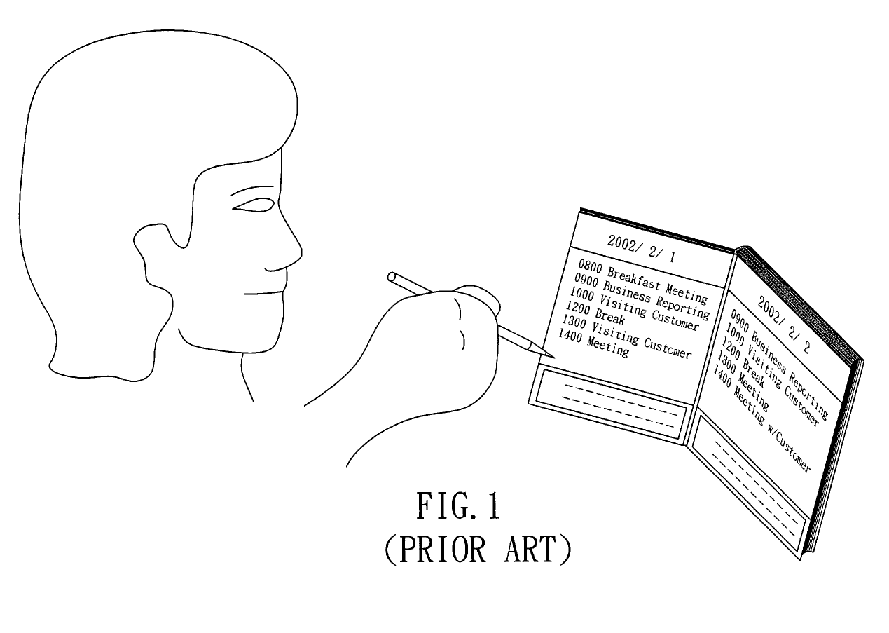

### DETAILED DESCRIPTION FOR THE PRESENT INVENTION

The present invention is to disclose a voice reminding system and method, which mainly pre-records different events as voice data, and then arranges a schedule for events through a detailed schedule editing program, and connects the event to the pre-recorded voice data. When an event is about to happen, the present invention's system will automatically play the voice data to remind the user and so attain the reminding purpose.

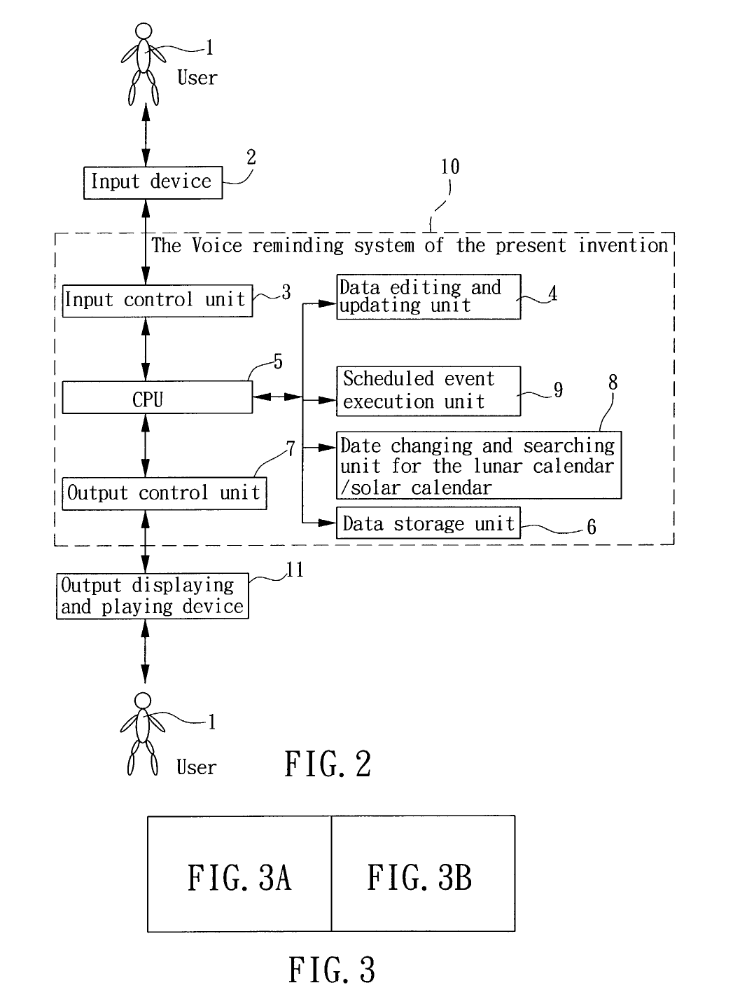

First please refer to FIG. 2; FIG. 2 is a system framework for the present invention. It can be known from FIG. 2 that this voice reminding system 10 comprises one input control unit 03 for connecting some input device 02, one CPU 05 for connecting each working unit of the present invention to process data and control work execution of each working unit, one data storage unit 06 for connecting the CPU 05 to store data, one data editing and updating unit 04 for connecting the CPU 05 to enable the user to edit and update data, one date changing and searching unit for the lunar calendar/solar calendar 08 for connecting the CPU 05 to change dates of the lunar calendar/solar calendar, and one output control unit 07 for connecting and controlling an output displaying and playing device 11. The input device 02 provides the user 01 with the function of data input. The output displaying and playing device 11 displays and plays data processed by the present invention for the user 01.

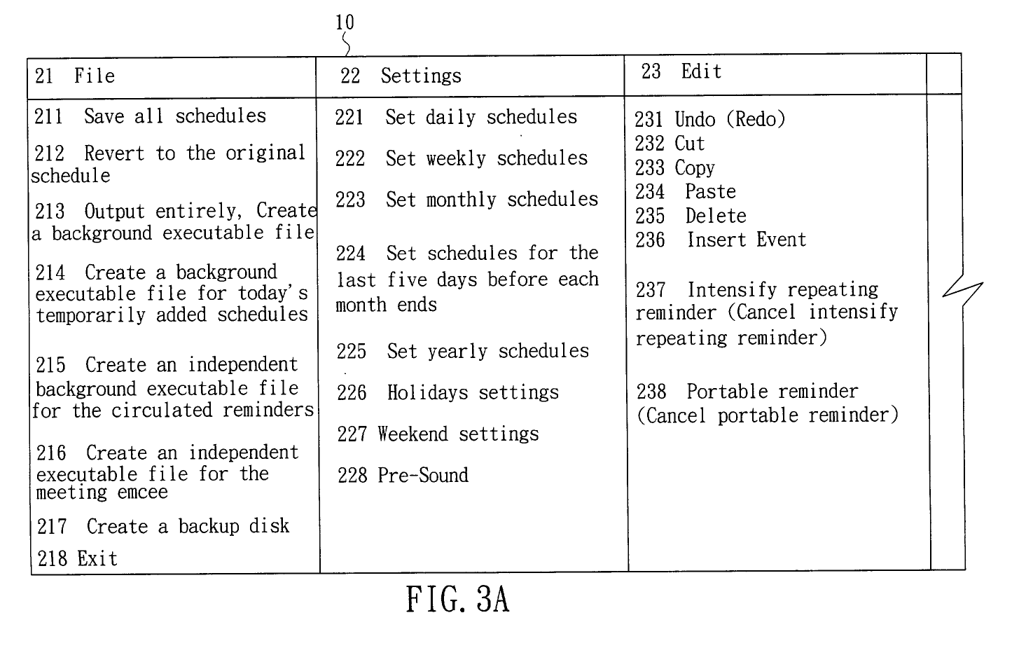

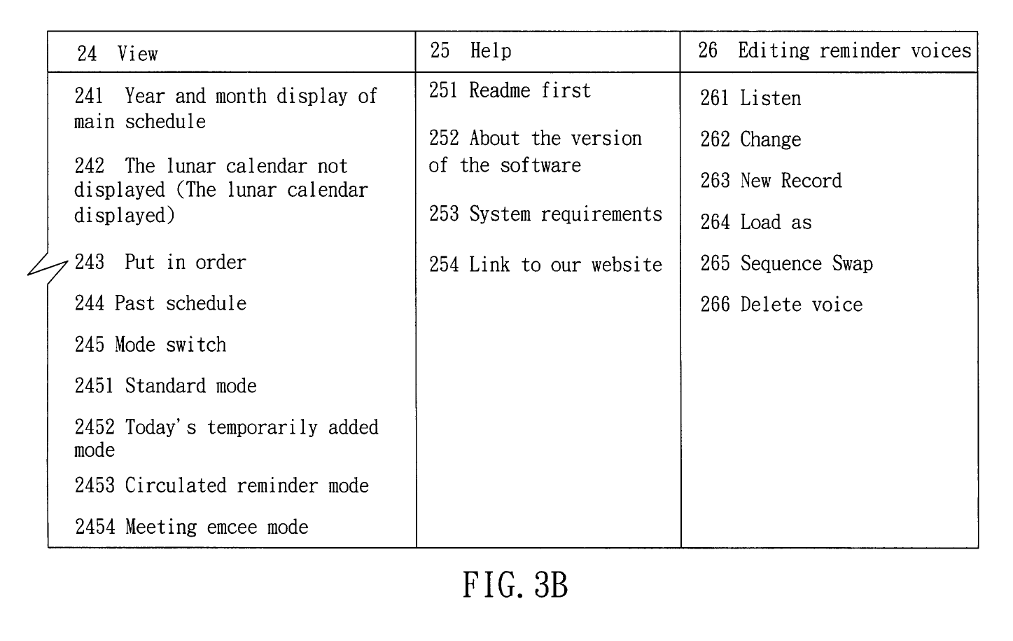

Next, please refer to FIG. 3A to FIG. 3B, which are the software functionality framework of the present invention. It can be known from FIG. 3A to FIG. 3B that the software functionality framework of this voice reminding system 10 is divided into six major sub systems, which include: one file processing function 21 (File for short), one setting function 22 (Settings for short), one editing function 23 (Edit for short), one viewing function 24 (View for short), one help function 25 (Help for short) and one editing reminder voices function 26 (Editing reminder voices for short). The description for the above functions is as follows: The file processing function 21 (File for short) includes the following sub-functions: Save all schedules 211; Revert to the original schedule 212; Output entirely, Create a background executable file 213; Create a background executable file for today's temporarily added schedules 214; Create an independent background executable file for the circulated reminders 215; Create an independent executable file for the meeting emcee 216; Create a backup disk 217; Exit 218. The setting function 22 (Settings for short) includes the following sub-functions: Set daily schedules 221; Set weekly schedules 222; Set monthly schedules 223; Set schedules for the last five days before each month ends 224; Set yearly schedules 225; Holidays settings 226; Weekend settings 227 and Pre-Sound 228. The editing function 23 (Edit for short) includes the following sub-functions: Undo (Redo) 231; Cut 232; Copy 233; Paste 234; Delete 235; Insert Event 236; Intensify repeating reminder (Cancel intensify repeating reminder) 237 and Portable reminder (Cancel portable reminder) 238. The viewing function 24 (View for short) includes the following sub-functions: Year and month display of main schedule 241; The lunar calendar not displayed (The lunar calendar displayed) 242; Put in order 243; Past schedule 244 and Mode switch 245, including Standard mode 2451, Today's temporarily added mode 2452; Circulated reminder mode 2453 and Meeting emcee mode 2454. The help function 25 (Help for short) includes the following sub-functions: Readme first 251; About the version of the software 252; System requirements 253 and Link to our website 254. The editing reminder voices function 26 (Editing Reminder Voices for short) includes the following sub-functions: Listen 261; Change 262; New Record 263; Load as 264; Sequence Swap 265 and Delete voice 266. To summarize, the software framework in the present invention includes complete functions, which will be specifically described as follows, excluding some of these functions, which are not covered in the claims of the present invention.

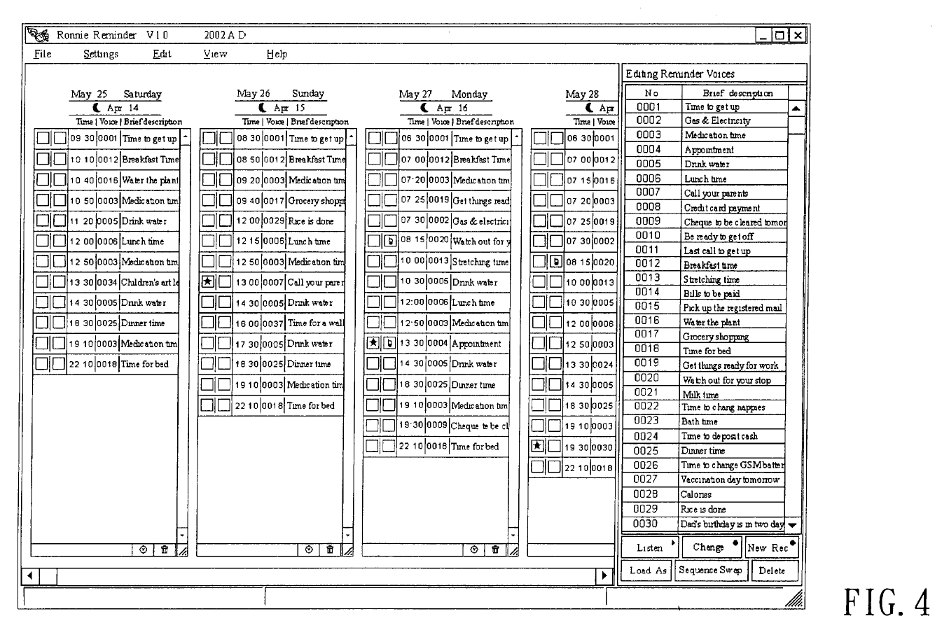

Please refer to FIG. 3A to FIG. 3B. The editing reminder voice function 26 (Editing Reminder Voices for short) in the software functionality framework of this voice reminding system 10 is to manage voice files of reminders. The user can directly use his/her own speech or his/her family members' or friends' speech as recording files, or the author can use recordists' recorded sample recording files to be recording approaches for editing schedules. Of course, brief descriptions added for the voice files can be set to display on schedule; the user can choose to display texts at the same time or not. Please see FIG. 3A to FIG. 3B and FIG. 4. As shown in FIG. 3A to FIG. 3B, this function includes the following sub-functions: Listen 261; Change 262; New Record 263; Load as 264; Sequence Swap 265 and Delete voice 266. Listen 261 function allows the user to listen to recorded reminders' voice files; the Change 262 function allows the user to change recorded reminders' voice files; the New Record 263 function allows the user to record new voice files for reminders; the Load as 264 function allows the user to load a recorded voice file or a voice file email received from someone to the system; the Sequence Swap 265 function allows the user to rearrange the sequence for the recorded voice files for reminders as shown in FIG. 4 (for example, the user can swap the reminder voice file 0006 “Eat lunch” with the other file 0014 “Pay bills”); the Delete 266 function allows the user to delete recorded reminder voice files.

Secondly, the Output entirely, create a background executable file 213 in the File processing 21 (File for short) function can create an executable program executed in the background, which enables the user to hear reminders using hardware such as PCs, notebook computers, PDAs, pocket PCs and new mobile phones. The “Create a background executable file for today's temporarily added schedules” 214 function can additionally create another executable program executed in the background according to today's temporarily added schedules; the user doesn't need to enter a specific schedule in the standard to edit schedules, which saves time for editing schedules. The “Create an independent background executable file for circulated reminders” 215 function can create an executable program executed in the background according to a series of events that proceed in order to repeatedly remind of important events. The “Create an independent executable file for the meeting emcee” 216 function is similar to an emcee in a meeting. The user can play pre-recorded reminder voice files in a meeting (or any occasions similar to meetings) to achieve the effect similar to an emcee controlling a meeting's agenda. Of course, the user can also play sounds or sound effects in dramas, singing and dancing programs or meeting presentations if necessary.

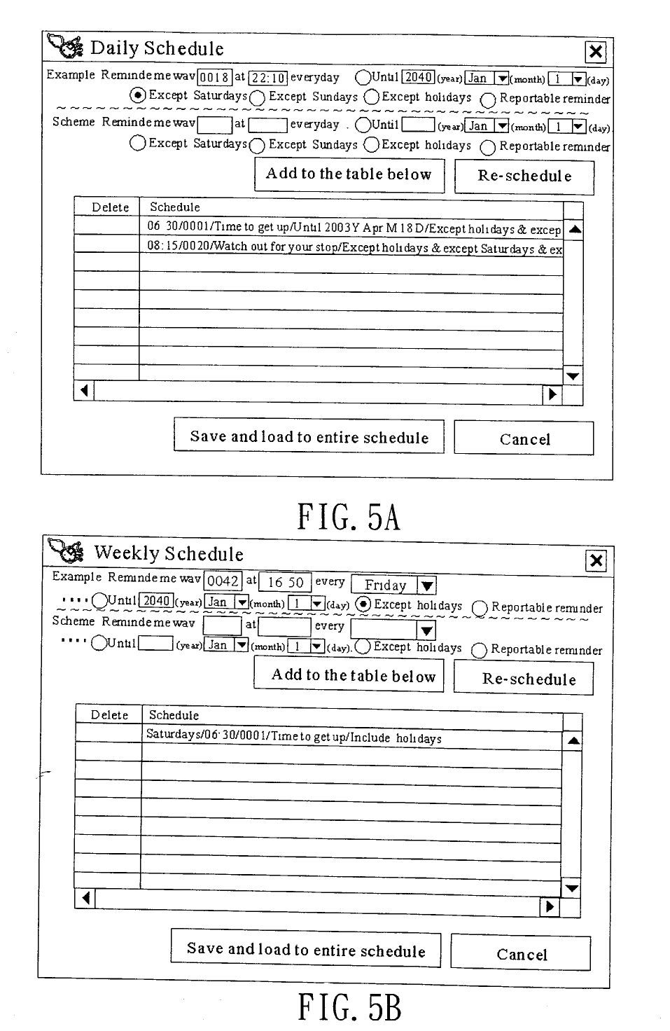

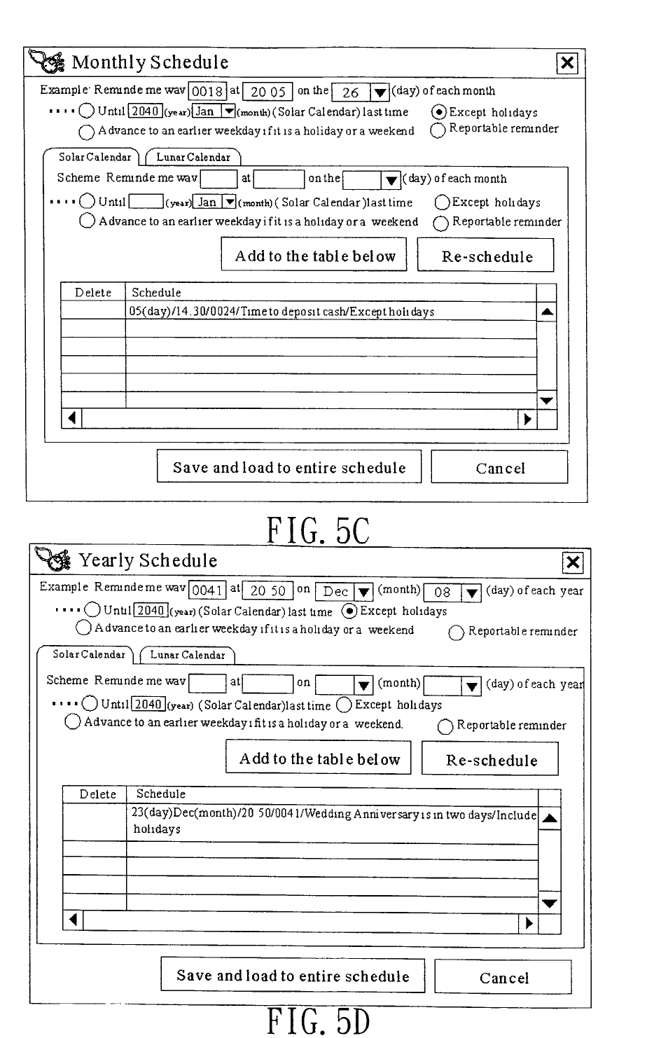

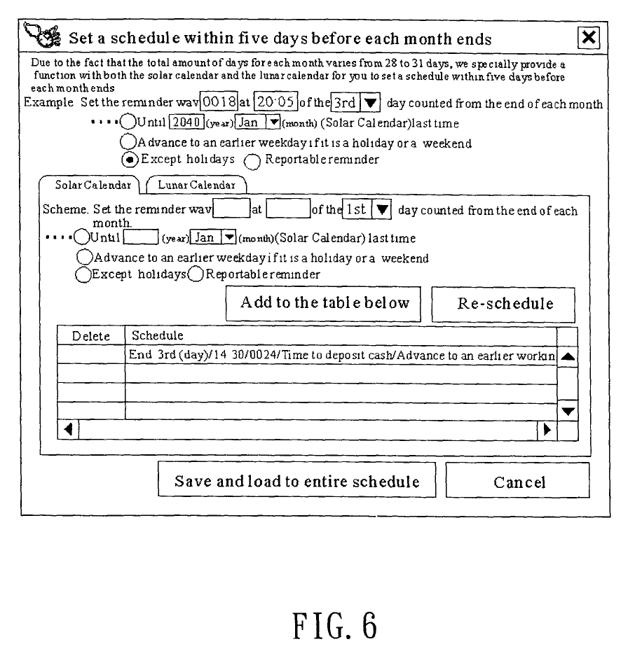

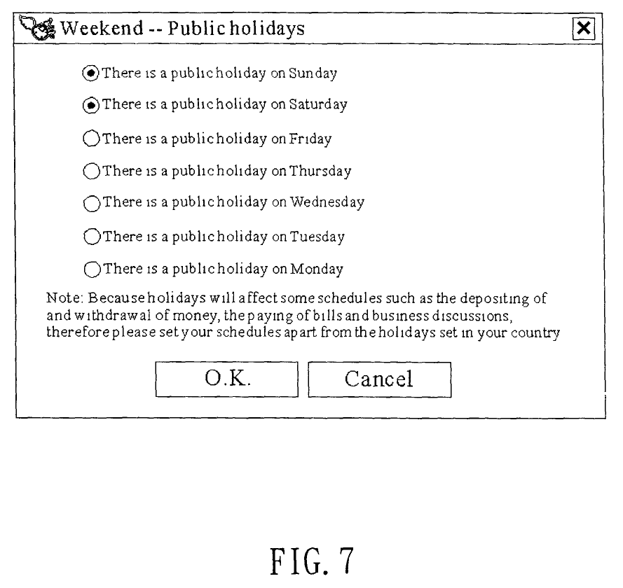

The “Setting” function 22 (Settings for short) includes different setting functions. In the present invention, “regular” and “exceptional” rules have been induced from people's originally chaotic and intertwined routines, and have been specified as specific setting methods. Please refer from FIG. 5(A) to FIG. 5(D). It can be known from FIG. 5(A) to FIG. 5(D) that the “Settings” function includes “Set daily schedules” 221, “Set weekly schedules” 222, “Set monthly schedules” 223 and “Set Yearly schedules” 225 to set daily, weekly, monthly and yearly reminding schedules in advance to be basis for all schedules. As shown in FIG. 6, the “Set schedules for the last five days before each month ends” 224 function can set fixed schedules for the last five days of every month at once, because there are 28 to 31 days every month in the solar calendar, and 28 to 30 days every month in the lunar calendar. Therefore this function is used by the present invention for planning and arranging schedules at the end of every month. As shown in FIG. 7, the “Holiday settings” 226 function can set holidays for each year, and so when setting daily, weekly, monthly and yearly reminding schedules, options are provided for excluding holidays, Saturdays and Sundays. The “Weekend holiday settings” function 227 is used to set national weekend holidays for public officials and bank staff. Because public officials' and bank staff's weekend holidays affect users' routines such as withdrawing money, paying bills and public business discussion, hence this function of the present invention can add weekend holidays as setting factors that affect schedules. The Pre-Sound function 228 plays a short piece of music before playing reminders to remind the user to pay attention to reminder contents.

The “Editing” function 23 (Edit for short) is used for editing schedule data, in which, the “Insert Event” function 236 is used for adding a specific schedule in addition to daily, weekly, monthly and yearly reminding schedules. Besides this, the invention also allows the user to directly select reminders from the “Edit reminder” window, drag them to the dates that need reminding, and then directly input reminding times. The “Intensify repeating reminders (Cancel intensify repeating reminders)” function 237 repeatedly plays reminders every few minutes for especially important events. The user can set the number of repetition times. The “Portable reminders (Cancel portable reminders)” function 238 is specifically designed for the user's convenience to use pocket PCs or mobile phones to play reminders for some outdoor schedules when not being able to use desktops, and for reducing the use of pocket PCs' or mobile phones' resources. Pocket PCs or mobile phones will only play schedules with “portable reminders” notes using this function, so as to significantly reduce requirements for files input to the above-mentioned hardware and resources. For example, set an approximate time for getting off the bus every day using a pocket PC or a cell-phone to remind you of this.

The “Viewing” function 24 (View for short) is used for viewing schedules in different ways. The “The lunar calendar not displayed (The lunar calendar displayed)” function 242 enables the user to choose to display (or not to display) the lunar calendar. This function provides the same setting convenience with the solar calendar to people who are accustomed to using the lunar calendar, and doesn't just display a certain date in the solar calendar as the date in the lunar calendar. Therefore, it can't be accomplished at once in other systems when setting events like practicing morning abstinence from meat on the 1^{st} of every month in the lunar calendar. Moreover, important events like a family member's birthday in the lunar calendar are very easily neglected and forgotten in the modem society where the use of solar and the lunar calendar is mixed. In the “Holiday settings” function 226, the same setting convenience is provided for people with different calendar use.

The “Mode switch” function 245 includes “Standard mode” 2451, “Today's temporarily added mode” 2452; “Circulated reminder mode” 2453 and “Meeting emcee mode”. Among which, the “Standard mode” 2451 is a complete mode and the major editing mode preset by the system and method of the present invention. The “Today's temporarily added mode” 2452 can rapidly generate an additional background executable file according to a certain day's temporarily arranged unexpected schedule without opening the specific schedule in the standard mode, for example, have a temporary nap for 20 minutes, or remember the water is still boiling in the kitchen. The “Circulated reminder mode” 2453 allows the user to set continuous, repeated and circulated reminders at a certain time for some continuing, repeated and mechanical work that happens in order; this background executable file is also additionally independent. The system will continuously circulate playing reminders until the user finally decides to stop it. The “Meeting emcee mode” 2454 prerecords a meeting emcee's asides and edits them into schedules. When pressing a certain key on the keyboard, the next aside will be played without precise time setting procedures. In addition, the voice reminding system and method of the present invention can edit the smallest unit for a schedule as a minute, which is different from other systems and methods in prior art that mostly use one hour or half an hour as a unit, and can only be used for typing to record events and setting an alarm sound without the function of directly displaying a spoken voice.

From the disclosure of the above-mentioned embodiments, the voice reminding system and method of the present invention truly has distinct improvement for increasing working efficiency and reducing working costs, provides pronounced methods and has specific effects for improving the defects of techniques of habitual use. The characteristics and all better implementation embodiments of the present invention have been revealed, which amply display the present invention's implementation progress regarding its purposes and effects. The present invention has the utmost industrial exploitation value, and is a hitherto unknown application in the market.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. A voice reminding system, comprising:
a input control unit for connecting input devices, which is used for providing a user with data input and editing functions;
CPU for connecting all working units to process data and control work execution of said every working unit;
a data storage unit for connecting the CPU to store data;
a data editing and updating unit for connecting the CPU to provide the user with editing and updated schedule data;
a date changing and searching unit for the lunar/solar calendar for connecting the CPU to search and change dates for the lunar calendar/solar calendar;
a scheduled event execution unit for connecting the CPU and process reminding data related to a certain time at a pre-scheduled time;
a output control unit for connecting and controlling an output displaying and playing device for displaying and playing processed data for the user.

2. The voice reminding system of claim 1, wherein the input device connected by the input control unit can be a computer keyboard.

3. The voice reminding system of claim 1, wherein the input device connected by the input control unit can be a computer mouse.

4. The voice reminding system of claim 1, wherein the input device connected by the input control unit can be a sound card and microphone.

5. The voice reminding system of claim 1, wherein the input device connected by the input control unit can be a mobile phone.

6. The voice reminding system of claim 1, wherein the data storage unit can be a database.

7. The voice reminding system of claim 1, wherein the data storage unit can be a data storage chip.

8. The voice reminding system of claim 1, wherein the data editing and updating unit can be used for recording voice data.

9. The voice reminding system of claim 1, wherein the data editing and updating unit can be used for trial listening voice data.

10. The voice reminding system of claim 1, wherein the data editing and updating unit can be used for deleting voice data.

11. The voice reminding system of claim 1, wherein the data editing and updating unit can be used for loading voice data.

12. The voice reminding system of claim 1, wherein the data editing and updating unit can adjust the sequence of voice data.

13. The voice reminding system of claim 1, wherein the data editing and updating unit can arrange event times using years as bases.

14. The voice reminding system of claim 1, wherein the data editing and updating unit can arrange event times using months as bases.

15. The voice reminding system of claim 1, wherein the data editing and updating unit can arrange event times using weeks as bases.

16. The voice reminding system of claim 1, wherein the data editing and updating unit can arrange event times using days as bases.

17. The voice reminding system of claim 1, wherein the data editing and updating unit can arrange event times using the last five days before every month ends as bases.

18. The voice reminding system of claim 1, wherein the data editing and updating unit can exclude exceptional situations from regular events using weekend holidays as a setting basis.

19. The voice reminding system of claim 1, wherein the data editing and updating unit can exclude exceptional situations from regular events using holidays as a setting basis.

20. The voice reminding system of claim 1, wherein the data editing and updating unit can play a piece of guiding music before the pre-scheduled events happen to remind the user of upcoming reminders.

21. The voice reminding system of claim 1, wherein the data editing and updating unit can create background executable programs for temporarily added schedules.

22. The voice reminding system of claim 1, wherein the data editing and updating unit can create independent executable programs for circulated reminders.

23. The voice reminding system of claim 1, wherein the data editing and updating unit can create an execution program and a circulated-reminding execution program for reminding with a temporary schedule, and play the next reminder using keys to control, which functions similarly to an emcee reminding in a meeting.

24. The voice reminding system of claim 1, wherein the data editing and updating unit can perform the following jobs: inserting a specific schedule in addition to daily, weekly, monthly and yearly reminding schedules.

25. The voice reminding system of claim 1, wherein the data editing and updating unit can connect various scheduled events and voice data.

26. The voice reminding system of claim 1, wherein the data editing and updating unit can repeatedly remind of a specific event for a certain number of times.

27. The voice reminding system of claim 1, wherein the data editing and updating unit can allow the user to select several scheduled events needed reminding when going out to be loaded in a portable device to perform reminding functions.

28. The voice reminding system of claim 1, wherein the date changing and searching unit for the lunar/solar calendar can arrange schedules according to the solar calendar.

29. The voice reminding system of claim 1, wherein the date changing and searching unit for the lunar/solar calendar can arrange schedules according to the lunar calendar.

30. The voice reminding system of claim 1, wherein the date changing and searching unit for the lunar/solar calendar can change an arranged schedule based on the lunar calendar into a solar calendar display.

31. The voice reminding system of claim 1, wherein the date changing and searching unit for the lunar/solar calendar can change an arranged schedule based on the solar calendar into a lunar calendar display.

32. The voice reminding system of claim 1, wherein the date changing and searching unit can change an arranged holiday based on the lunar calendar into a solar calendar display.

33. The voice reminding system of claim 1, wherein the date changing and searching unit for the lunar/solar calendar can change an arranged holiday based on the solar calendar into a lunar calendar display.

34. The voice reminding system of claim 1, wherein the output display device connected by the output control unit can be a computer screen.

35. The voice reminding system of claim 1, wherein the output display device connected by the output control unit can be a sound card and speakers.

36. The voice reminding system of claim 1, wherein the output display device connected by the output control unit can be a pocket PC.

37. The voice reminding system of claim 1, wherein the output display device connected by the output control unit can be a PDA (Personal Digital Assistant).

38. The voice reminding system of claim 1, wherein the output display device connected by the output control unit can be a mobile phone.

39. The voice reminding system of claim 1, wherein the data format output by the output control unit can be texts.

40. The voice reminding system of claim 1, wherein the data format output by the output control unit can be voice based speeches.

41. The voice reminding system of claim 1, wherein a smallest time unit used thereby is one minute.

42. A voice reminding method, which comprising the following steps:
(a). pre-recording different events as voice data, and then storing the voice data in a data storage unit;
(b). using a software program to set event times for various regularly-occurring events every day, every week, every month, the last five days of every month and every year and excluding exceptional events' time of occurrence;
(c). connecting the events to the related pre-recorded voice data;
(d). when an event occurs, the voice data will be automatically played through an output device to remind the user of an upcoming event to attain the reminding purpose.

43. The voice reminding method of claim 42, wherein the data storage unit can be a database.

44. The voice reminding method of claim 42, wherein the data storage unit can be a data storage chip.

45. The voice reminding method of claim 42, wherein the output device can be a desktop computer.

46. The voice reminding method of claim 42, wherein the output device can be a notebook computer.

47. The voice reminding method of claim 42, wherein the output device can be a pocket PC.

48. The voice reminding method of claim 42, wherein the output device can be a PDA.

49. The voice reminding method of claim 42, wherein the output device can be a mobile phone.

50. The voice reminding method of claim 42, wherein the smallest time unit used thereby is one minute.
